(19) United States
(12) Patent Application Publication
(10) Pub. No.: US 2015/0130907 A1
(43) Pub. Date: May 14, 2015

(54) PLENOPTIC CAMERA DEVICE AND SHADING CORRECTION METHOD FOR THE CAMERA DEVICE

(71) Applicant: SAMSUNG ELECTRONICS CO., LTD., Suwon-Si (KR)

(72) Inventors: Dae-Kwan KIM, Suwon-si (KR); Tae-Chan KIM, Yongin-si (KR); Jung Hoon JUNG, Hwaseong-si (KR)

(21) Appl. No.: 14/532,593

(22) Filed: Nov. 4, 2014

Related U.S. Application Data
(60) Provisional application No. 61/902,419, filed on Nov. 11, 2013.

(30) Foreign Application Priority Data
Feb. 25, 2014 (KR) 10-2014-0022128

(51) Int. Cl. H04N 5/235; H04N 13/02

(52) U.S. Cl. CPC H04N 5/2354; H04N 13/0203
USPC 348/46

(57) ABSTRACT

A plenoptic camera device and a shading correction method thereof are provided. The plenoptic camera device includes a processor including a shading correction block configured to determine a four-dimensional axis with respect in a raw image, generate a four-dimensional profile by applying a polynomial fit with respect to the plurality of pixels in the raw image based on the four-dimensional axis, and calculate a gain using the four-dimensional profile and a non-volatile memory device configured to store the gain. Accordingly, the plenoptic camera device can remove a vignetting effect using the gain.

### CROSS-REFERENCE TO RELATED APPLICATION

This application claims the benefit of provisional U.S. Application No. 61/902,419filed on Nov. 11, 2013, and also claims priority under 35 U.S.C. §119 to Korean Patent Application No. 10-2014-0022128 filed on Feb. 25, 2014, the disclosure of each of which is hereby incorporated by reference in its entirety.

### BACKGROUND

1. Field

Example embodiments of inventive concepts relate to a plenoptic camera device, and a shading correction method for the camera device.

2. Description of Related Art

A plenoptic camera device or a light field camera device can capture light distribution information and light direction information in a light field. Images obtained by the camera device can be collected with an increased focus depth, or the images can be digitized and the images can be adjusted. In a standard plenoptic camera device, a micro lens array is located in front of an image plane, for example, a photographic plate or a photosensor array. This construction generates light with a focus on a specific plane and obtains a light field coming out of the lens array. A final image can be generated from raw data recorded using a computer algorithm.

A vignetting effect causes an image obtained from the camera device to be bright in a center area of the image and dark in a boundary area of the image.

When the vignetting effect is generated in the plenoptic camera device, a shading correction method that is used in a general camera cannot be applied to the plenoptic camera device.

### SUMMARY

Example embodiments of inventive concepts provide a plenoptic camera device capable of correcting a vignetting effect.

Example embodiments of inventive concepts also provide a shading correction method of the plenoptic camera device.

Inventive concepts are not limited to the above disclosure; other objectives may become apparent to those of ordinary skill in the art based on the following descriptions.

In accordance with an example embodiment of inventive concepts, a plenoptic camera device having an image sensor that includes a plurality of pixels, includes a processor including, a shading correction block configured to determine a four-dimensional axis with respect in a raw image, generate a four-dimensional profile by applying a polynomial fit with respect to the plurality of pixels in the raw image based on the four-dimensional axis, and calculate a gain using the four dimensional profile; and a non-volatile memory device configured to store the gain.

In an example embodiment, the plenoptic camera device may further include a mask including a plurality of lenslets; and an image sensor configured to capture the raw image through each of the plurality of lenslets.

In an example embodiment, the raw image may include a plurality of sub-images corresponding to the plurality of lenslets.

In an example embodiment, the four-dimensional axis may include a two-dimensional axis for selecting one of the sub-images and a two-dimensional axis for selecting one of pixels in the selected sub-image.

In an example embodiment, the two-dimensional axis for selecting one of the sub-images may include a horizontal axis and a vertical axis for selecting one of the sub-images.

In an example embodiment, the two-dimensional axis for selecting the one of pixels in the selected sub-image may include a horizontal axis and a vertical axis for selecting the one of the pixels in the selected sub-image.

In an example embodiment, the shading correction block may remove a pixel with a value that is equal to or smaller than a threshold value among the plurality of pixels

In an example embodiment, the shading correction block may generate the four-dimensional profile according to a focus, a zoom, and an integration time of the plenoptic camera device.

In an example embodiment, the shading correction block may remove a vignetting effect using the gain.

In accordance with another example embodiment of inventive concepts, a method includes receiving a raw image, determining a four-dimensional axis with respect to the raw image, generating a four-dimensional profile by applying a polynomial fit with respect to a plurality of pixels in the raw image based on the four-dimensional axis, and calculating a gain using the four-dimensional profile.

In an example embodiment, the method may further include removing pixels with values that are equal to or smaller than a threshold value among the plurality of pixels.

In an example embodiment, the determining of the four-dimensional axis, may include determining a two-dimensional axis for selecting one of a plurality of sub-images corresponding to a plurality of lenslets, and determining a two-dimensional axis for selecting a pixel in the selected sub-image.

In an example embodiment, the two-dimensional axis for selecting one of the plurality of the sub-images may include a first horizontal axis and a first vertical axis for selecting the sub-image, and the two-dimensional axis for selecting the pixel in the selected sub-image one among the pixels may include a second horizontal axis and a second vertical axis.

In an example embodiment, the generating of the four-dimensional profile may include generating the four-dimensional profiles according to a focus, a zoom, and an integration time of the plenoptic camera device.

In an example embodiment, the method may further include removing a vignetting effect using the gain.

At least one example embodiment discloses a method of correcting shading in an image. The method includes obtaining data values from an image sensor array having a plurality of pixels, the image sensor array being modeled as a four dimensional surface, the data values being in accordance with a response curve; and applying gain values to the data values, respectively, in accordance with a gain curve, the gain curve being symmetric to the response curve with respect to an axis.

In an example embodiment, the axis represents a distance from a location in the image sensor array.

In an example embodiment, the response curve has a minimum value corresponding to a boundary of the image sensor array and a maximum value corresponding to a center of the image sensor array.

In an example embodiment, the gain curve has a minimum value corresponding to a center of the image sensor array and a maximum value corresponding to a boundary of the image sensor array.

### BRIEF DESCRIPTION OF THE DRAWINGS

The foregoing and other features and advantages of inventive concepts will be apparent from the more particular description of example embodiments of the inventive concepts, as illustrated in the accompanying drawings in which like reference characters refer to the same parts throughout the different views. The drawings are not necessarily to scale, emphasis instead being placed upon illustrating the principles of inventive concepts. In the drawings:

FIG. 1 illustrates a plenoptic camera device according to an example embodiment of inventive concepts;

FIG. 2 is a block diagram illustrating an image processing device for processing an image of the plenoptic camera device shown in FIG. 1 in detail;

FIG. 3A illustrates an image for describing a vignetting effect;

FIG. 3B illustrates an enlarged image of a portion of the image shown in FIG. 3A;

FIG. 3C illustrates a light source with even illumination;

FIG. 4A is a graph illustrating a relationship between a response and a distance when a two-dimensional image shown in FIG. 3A is converted into a one-dimensional image;

FIG. 4B is a graph showing a profile generated by applying a polynomial fit with respect to a plurality of points shown in FIG. 4A;

FIG. 4C is a graph showing a profile and a gain;

FIG. 5 is a graph illustrating a response according to 1 integration time and 0.5 integration time;

FIG. 6A illustrates an white image;

FIG. 6B illustrates a dark image;

FIG. 7 is a graph illustrating a gain according to a distance;

FIG. 8A is a graph illustrating a gain according to an integration time at a point A shown in FIG. 7;

FIG. 8B is a graph illustrating a gain according to an integration time at a point B shown in FIG. 7;

FIG. 9A is a graph illustrating a response curve according to 1 integration time;

FIG. 9B is a graph illustrating a gain curve according to 1 integration time;

FIG. 9C is a graph illustrating a result obtained by multiplying the response curve shown in FIG. 9A and the gain curve shown in FIG. 9B;

FIG. 10A is a graph illustrating a response curve according to 0.5 integration time;

FIG. 10B is a graph illustrating a gain curve according to 0.5 integration time;

FIG. 10C is a graph illustrating a result obtained by multiplying the response curve shown in FIG. 10A and the gain curve shown in FIG. 10B;

FIG. 11A illustrates an image of an object captured by a plenoptic camera device;

FIG. 11B is an enlarged diagram of a first portion of the image shown in FIG. 5A;

FIG. 11C is an enlarged diagram of a second portion of the image shown in FIG. 5A;

FIG. 12 illustrates an image captured by a plenoptic camera device before applying a shading correction method;

FIG. 13 illustrates an image captured by a plenoptic camera device after applying a shading correction method;

FIG. 14A illustrates an epipolar slice image of the image shown in FIG. 6;

FIG. 14B illustrates an epipolar slice image of the image shown in FIG. 7;

FIG. 15 is a flowchart for describing a shading correction method of a plenoptic camera device according to an example embodiment of inventive concepts;

FIG. 16 is a flowchart for explaining a shading correction method of a plenoptic camera device according to another example embodiment of inventive concepts;

FIG. 17 is a computer system according to an example embodiment of inventive concepts; and

FIG. 18 is a computer system according to another example embodiment of inventive concepts.

### DETAILED DESCRIPTION OF EXAMPLE EMBODIMENTS

Example embodiments are described below in sufficient detail to enable those of ordinary skill in the art to embody and practice inventive concepts. It is important to understand that inventive concepts may be embodied in many alternate forms and should not be construed as limited to example embodiments set forth herein.

Various example embodiments will now be described more fully with reference to the accompanying drawings in which example embodiments are shown. Inventive concepts may, however, be embodied in different forms and should not be construed as limited to the embodiments set forth herein. Although a few example embodiments of inventive concepts have been shown and described, it would be appreciated by those of ordinary skill in the art that changes may be made in example embodiments without departing from the principles and spirit of inventive concepts, the scope of which is defined in the claims and their equivalents.

It will be understood that, although the terms first, second, A, B, etc. may be used herein in reference to elements of example embodiments, such elements should not be construed as limited by these terms. For example, a first element could be termed a second element, and a second element could be termed a first element, without departing from the scope of inventive concepts. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe example embodiments of inventive concepts is not intended to limit the scope of inventive concepts. The articles “a,” “an,” and “the” are singular in that they have a single referent, however the use of the singular form in the present document should not preclude the presence of more than one referent. In other words, elements of inventive concepts referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which inventive concepts belong. It will be further understood that terms in common usage should also be interpreted as is customary in the relevant art and not in an idealized or overly formal sense unless expressly so defined herein.

Meanwhile, when it is possible to implement any embodiment in any other way, a function or an operation specified in a specific block may be performed differently from a flow specified in a flowchart. For example, consecutive two blocks may actually perform the function or the operation simultaneously, and the two blocks may perform the function or the operation conversely according to a related operation or function.

Example embodiments of inventive concepts will be described below with reference to accompanying drawings.

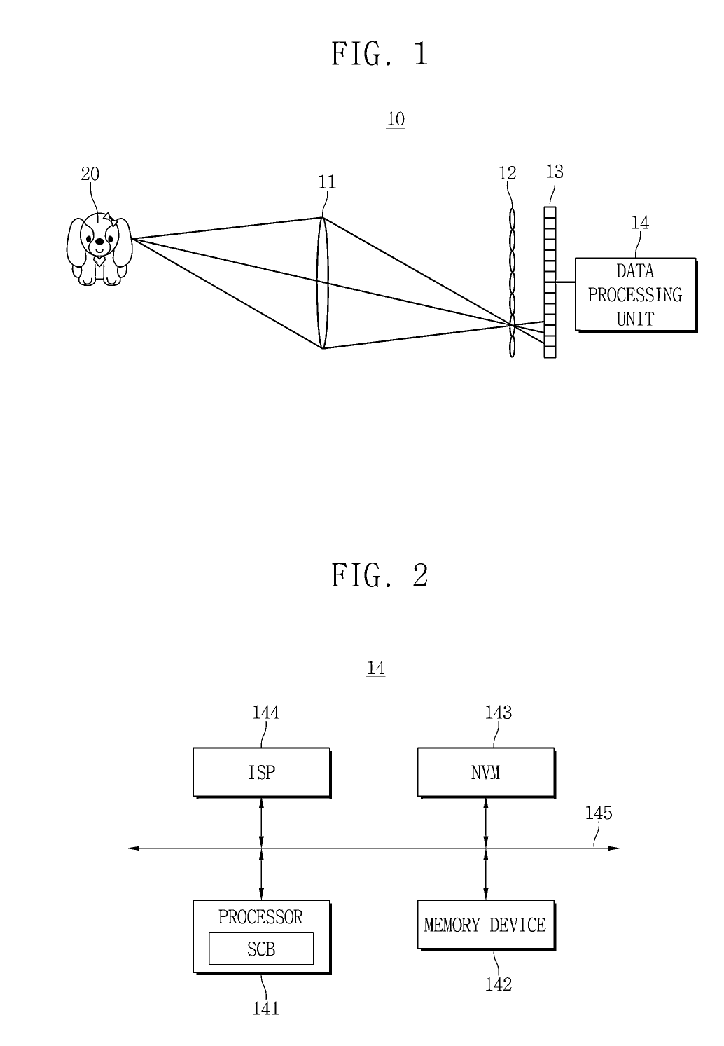

FIG. 1 illustrates a plenoptic camera device according to an example embodiment of inventive concepts.

Referring to FIG. 1, a plenoptic camera device 10 may include a lens 11, a mask 12, an image sensor 13, and a data processing unit 14. In an example embodiment, the plenoptic camera device 10 may be implemented as a camera, or various electronic products including the camera. For example, the plenoptic camera device 10 may be implemented as a camera module for a smart phone, or a tablet personal computer (PC).

An image of an object 20 (or a scene including the object) passing through an optic device such as a lens 11 may be obtained as light field data with respect to the object 20 in the image sensor 13 through the mask 12.

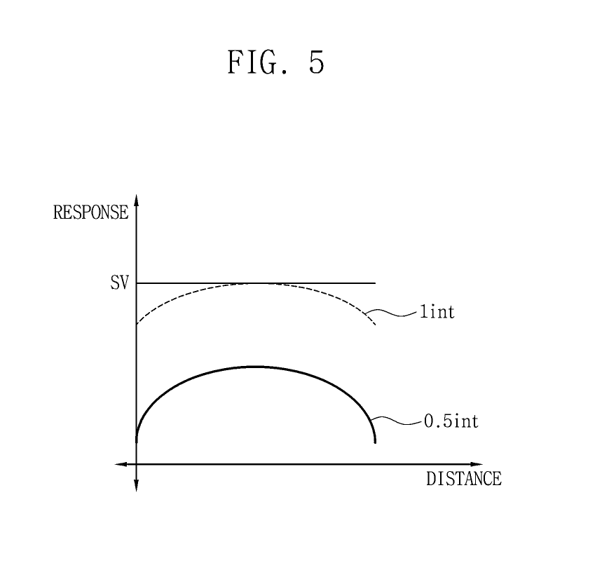

The mask 12 may be disposed between the lens 11 and the image sensor 13. The mask 12 and the lens 11 may be disposed in parallel. Further, the mask 12 may be disposed on the image sensor 13. The mask 12 may include a plurality of lenslets which are arranged in a honeycomb shape. A lenslet may be referred to as a microlens. The shape of the mask 12 will be described with reference to FIGS. 5B and 5C.

The image sensor 13 provides data to a two-dimensional image based on the light received. The image sensor 13 may sense the two-dimensional image including a plurality of pixels.

The data processing unit 14 may store the light field data with respect to the object 20, and/or rearrange a focus using the light field data. In an example embodiment, the data processing unit 14 may be a microprocessor or digital signal processor for processing the sensed image.

The data processing unit 14 may generate a four-dimensional axis for correcting a vignetting effect, and calculate a gain for correcting the vignetting effect using the four-dimensional axis. The data processing unit 14 may correct the vignetting effect using the gain. The data processing unit 14 will be described in detail with reference to FIG. 2.

FIG. 2 is a block diagram illustrating an image processing device for processing an image of the plenoptic camera device shown in FIG. 1 in detail.

Referring to FIGS. 1 and 2, the data processing unit 14 includes a processor 141, a memory device 142, a non-volatile memory device (NVM) 143, and an image signal processor (ISP) 144.

The processor 141 may drive an operating system. In an example embodiment, when the plenoptic camera device 10 is installed in a smart phone or a tablet PC, the operating system may be Android™. Further, the processor 141 may include a shading correction block (SCB) for removing the vignetting effect. The SCB generates a four-dimensional profile for removing the vignetting effect, and calculates a gain for removing the vignetting effect using the four-dimensional profile. The SCB can correct the vignetting effect using the gain.

In an example embodiment, the SCB may be implemented as one functional block in the processor 141.

The shading correction block may be hardware, firmware, hardware executing software or any combination thereof. When the shading correction block is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the shading correction block.

In the event where shading correction block is a processor executing software, the processor is configured as a special purpose machine to execute the software, stored in a storage medium, to perform the functions of the shading correction block. In such an embodiment, the processor 141 may perform the functions of the shading correction block.

The memory device 142 may store image data transmitted from the image sensor 13. The NVM 143 may store the gain for removing the vignetting effect. In an example embodiment, the NVM 143 may be implemented as one time programmable (OTP) memory device. The ISP 144 processes the image data transmitted from the image sensor 13.

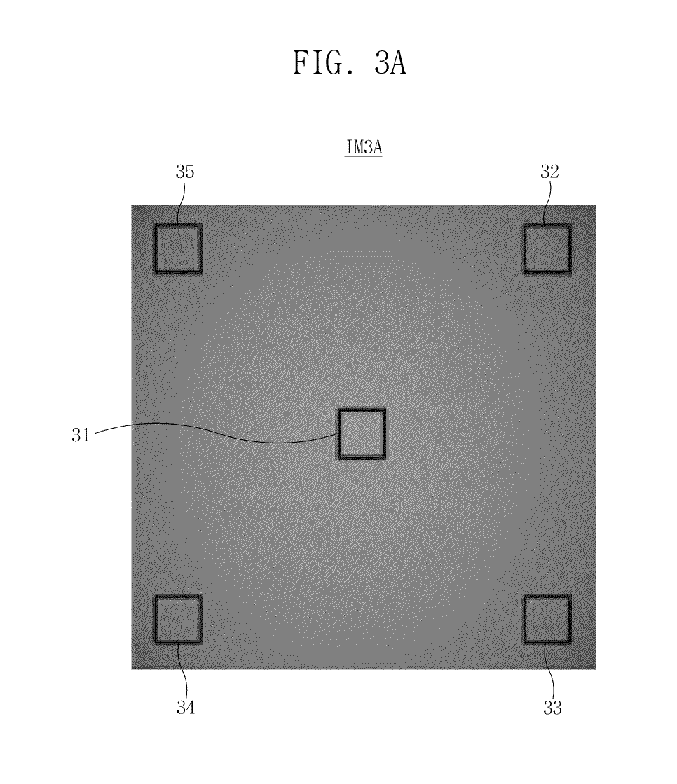

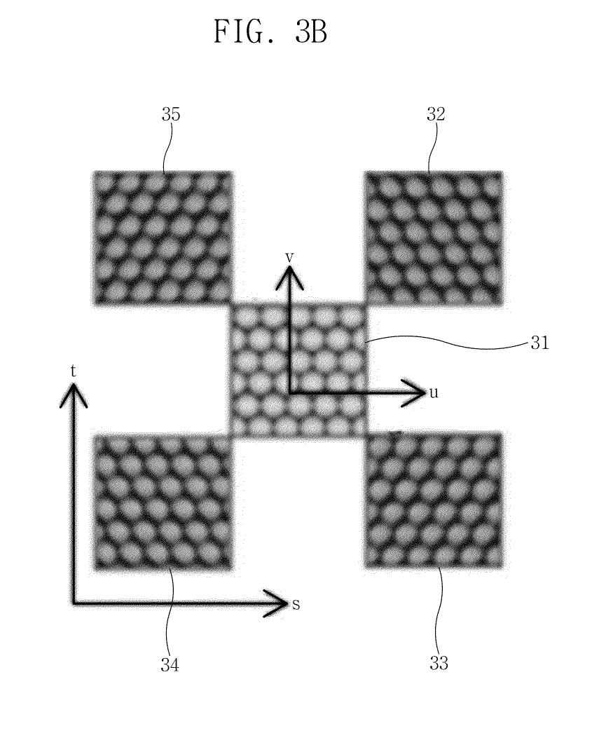

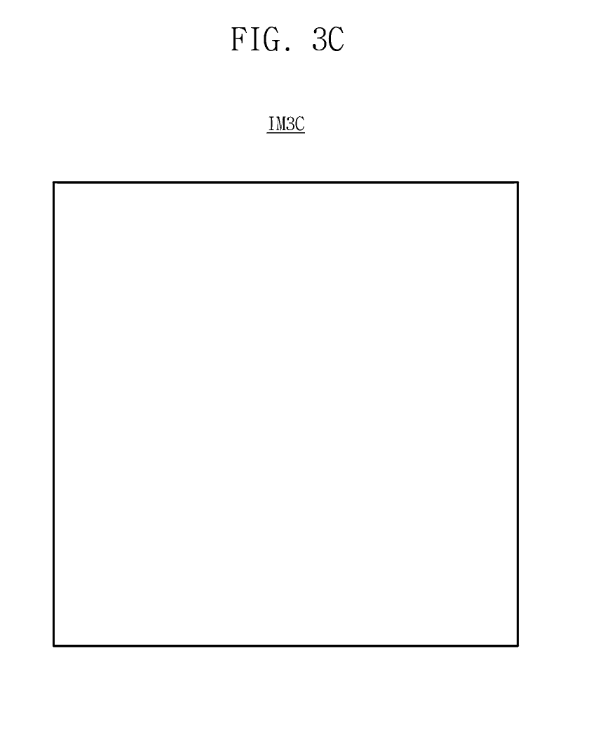

FIG. 3A illustrates an image for describing a vignetting effect.

Referring to FIGS. 1 and 3A, an image IM3A may include first to fifth sub-images 31, 32, 33, 34 and 35. Specifically, the first sub-image 31 is located in the center of the image 30. The second to fifth sub-images 32 to 35 are located in a boundary of the image 30.

The first sub-image 31 corresponding to the center of the lens 11 has the highest response. On the contrary, each of the second to fifth sub-images 32 to 35 corresponding to the boundary of the lens 11 has a low response. That is, the image IM3A has the vignetting effect. Here, the response is a digital value corresponding to brightness of the image IM3A.

To remove the vignetting effect, a conventional camera device uses a method of obtaining an image from a single/constant light source. The method may be a method of modeling the response of the image sensor as a two-dimensional shading profile.

However, the plenoptic camera device 10 according to an example embodiment of inventive concepts uses a lenslet-based method. Accordingly, since a shading profile with respect to each of the lenslets is generated, the image generated from the lenslet-based plenoptic camera device 10 cannot be modeled as the two-dimensional shading profile.

To solve the problem, the plenoptic camera device 10 according to an example embodiment of inventive concepts uses a four-dimensional shading profile obtained by adding the conventional two-dimensional shading profile and the two-dimensional shading profile with respect to each of the lenslets. The four-dimensional shading profile will be described with reference to FIG. 3B.

FIG. 3B illustrates an enlarged image of a portion of the image shown in FIG. 3A.

Referring to FIGS. 1, 3A and 3B, to remove the vignetting effect, the plenoptic camera device 10 uses a four-dimensional axis. A conventional camera device uses a two-dimensional profile (x, y), but the plenoptic camera device 10 uses a four-dimensional profile (s, t, u, v).

The conventional camera device uses the two-dimensional profile to remove the vignetting effect. The two-dimensional profile includes an axis (that is, x axis) with respect to a horizontal direction of the image 30 and an axis (that is, y axis) with respect to a vertical direction of the image 30.

On the contrary, the plenoptic camera device 10 uses the four-dimensional profile to remove the vignetting effect. The four-dimensional profile includes an s axis with respect to the horizontal direction axis of the image 30, a t axis with respect to the vertical direction of the image 30, a u axis with respect to a horizontal direction of a sub-image (that is, a sub-image selected from the first to fifth sub-images 31 to 35), and a v axis with respect to a vertical direction of the sub-image (that is, a sub-image selected from the first to fifth sub-images 31 to 35).

That is, the plenoptic camera device 10 may select the sub-image using the s and t axes, and select a pixel in the selected sub-image using the u and v axes.

Further, the four-dimensional profile may differ according to focus, zoom, and integration time of the plenoptic camera device 10. The integration time may be a time that the image sensor 13 senses an image.

FIG. 3C illustrates a light source with even illumination.

Referring to FIG. 3C, a light source IM3C with even illumination 36 has characteristics in which illumination of the center of the light source is equal to that of the boundary of the light source.

To remove the vignetting effect, the plenoptic camera device 10 may use the light source with the even illumination. That is, the plenoptic camera device 10 obtains a difference (a gain) between the center and the boundary of the light source from the light source with the even illumination. Accordingly, the plenoptic camera device 10 can remove the vignetting effect using the gain.

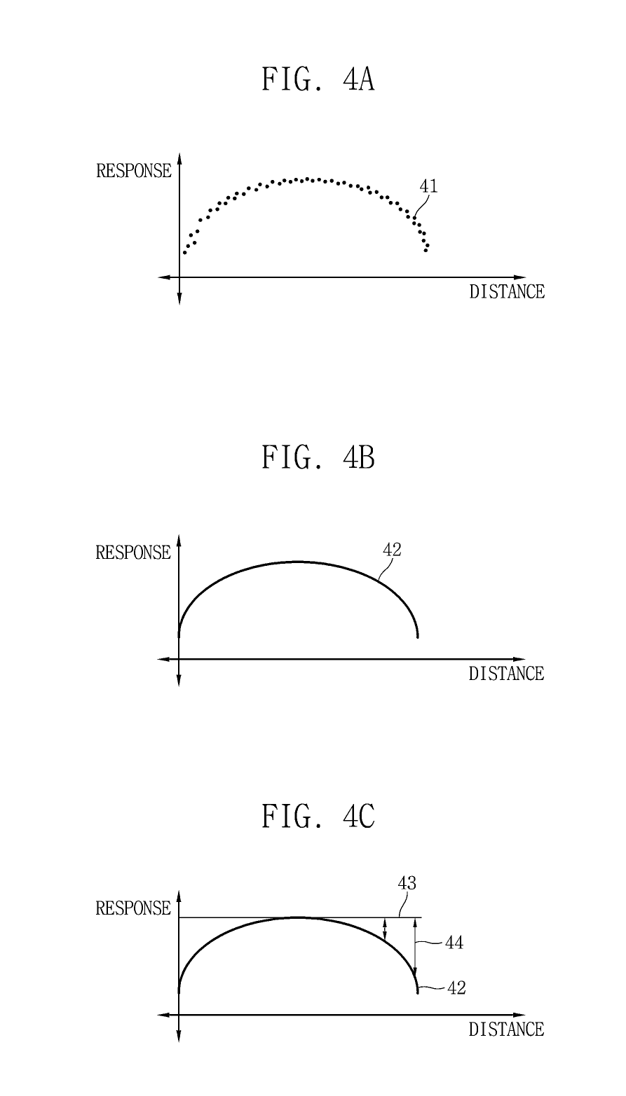

FIG. 4A is a graph illustrating a relationship between a response and a distance when a two-dimensional image shown in FIG. 3A is converted into a one-dimensional image.

Referring to FIGS. 2, 3A and 4A, a horizontal axis represents a horizontal axis or a vertical axis (that is, a distance) of an image 30. A vertical axis represents a response with respect to the horizontal axis or the vertical axis of the image 30. The response may be a digital value corresponding to illumination of the two-dimensional image. That is, the response is the digital value with respect to a horizontal distance of the image 30.

Further, the SCB may obtain the response with respect to each of every pixel included in the image 30 shown in FIG. 3A, but in this case, an amount of calculations for obtaining a profile may be abruptly increased. Accordingly, the SCB may obtain the profile using only the response with respect to a portion of pixels included in the image 30.

The response corresponding to each pixel of the two-dimensional image may be represented as a plurality of points 41. Due to the vignetting effect, the illumination of the center of the two-dimensional image 30 is high, and the illumination of the boundary of the two-dimensional image 30 is low. Accordingly, the response is high in a portion corresponding to the center of the image 30, and the response is low in both ends corresponding to the boundary of the image 30.

FIG. 4B is a graph showing a profile generated by applying a polynomial fit with respect to a plurality of points shown in FIG. 4A.

Referring to FIGS. 2, 4A and 4B, the SCB may generate a profile 42 by applying a polynomial fit with respect to a plurality of points 41. In an example embodiment, the polynomial fit may be expressed using a polynomial equation.

FIG. 4C is a graph showing a profile and a gain.

Referring to FIGS. 3A and 4C, when the vignetting effect is completely removed from the image 30, the response corresponding to the image 30 may be represented as a straight line 43. That is, when there is no vignetting effect in the image 30, the response according to the distance may be always constant.

The gain 44 is defined as a difference between the straight line 43 and a profile 42. Accordingly, when the gain 44 is added to the profile 42, the vignetting effect can be removed.

A method of obtaining a profile according to an integration time will be described with reference to FIGS. 5 to 10C.

FIG. 5 is a graph illustrating a response according to 1 integration time and 0.5 integration time.

Referring to FIGS. 1 and 5, X axis represents a distance on an image, Y axis represents a response according to the distance. For example, the response may include a digital data value of a pixel.

A time in which the image sensor 13 receives a light until a maximum value of a response curve 1 int according to the distance reaches a saturated value SV may be defined as 1 integration time.

Further, a time in which the image sensor 13 receives a light until a maximum value of a response curve 0.5 int according to the distance reaches ½ of a saturated value SV may be defined as 0.5 integration time.

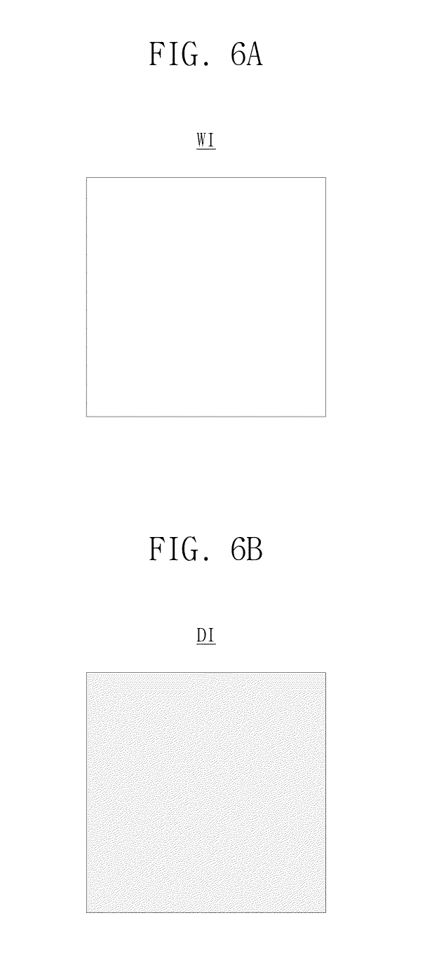

FIG. 6A illustrates a white image.

Referring to FIGS. 1 and 6A, when the image sensor 13 receives a light during 1 integration time, the plenoptic camera device 10 may generate a white image WI.

FIG. 6B illustrates a dark image.

Referring to FIGS. 1 and 6B, when the image sensor 13 receives a light during 0.5 integration time, the plenoptic camera device 10 may generate a dark image DI.

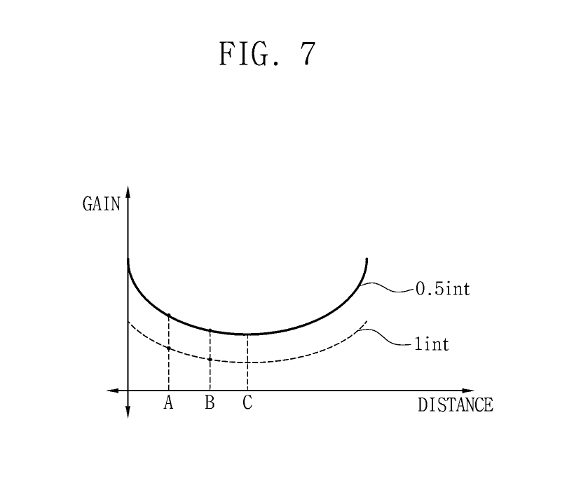

FIG. 7 is a graph illustrating a gain according to a distance.

Referring to FIGS. 1 and 7, X axis represents a distance on an image, and Y axis represents a gain according to the distance.

A first curve 1 int may represent a gain according to 1 integration time. A second curve 0.5 int may represent a gain according to 0.5 integration time.

A point C may represent a center of an image. The point A may be farther away from the point C, which is the center of the image, than a point B.

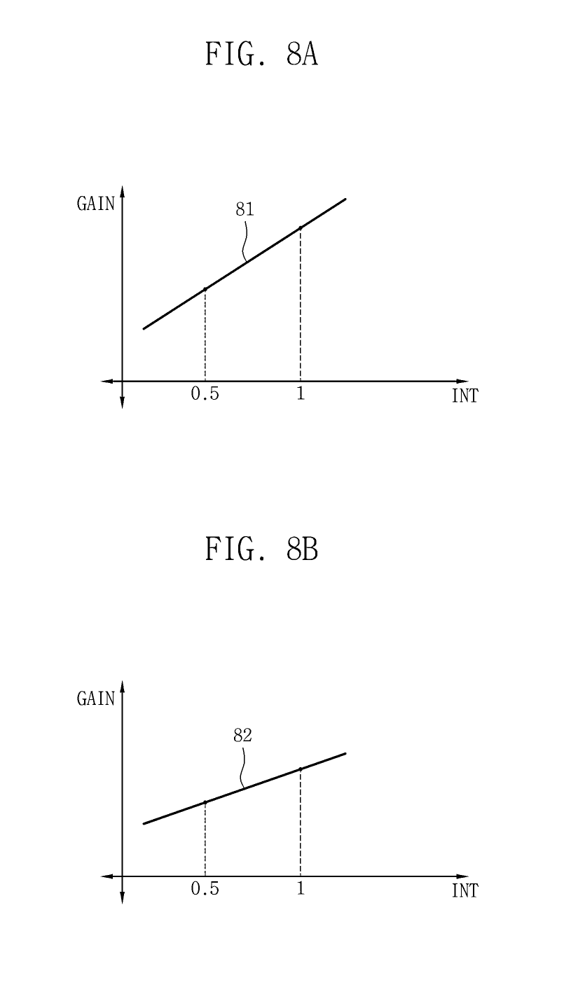

FIG. 8A is a graph illustrating a gain according to an integration time at a point A shown in FIG. 7, and FIG. 8B is a graph illustrating a gain according to an integration time at a point B shown in FIG. 7.

Referring to FIGS. 8A and 8B, a first straight line 81 may represent a gain according to an integration time with respect to the point A. Similarly, a second straight line 82 may represent a gain according to an integration time with respect to the point B.

The first straight line 81 may have a greater slope than the second straight line 82. This may mean that a brightness is less in a boundary of the image than the center of the image. That is, due to the vignetting effect, the image may darken from the center of the image to the edge of the image.

For convenience of description, suppose that the gain according to the integration time has linearity. However, actually, the gain according to the integration time may have non-linearity.

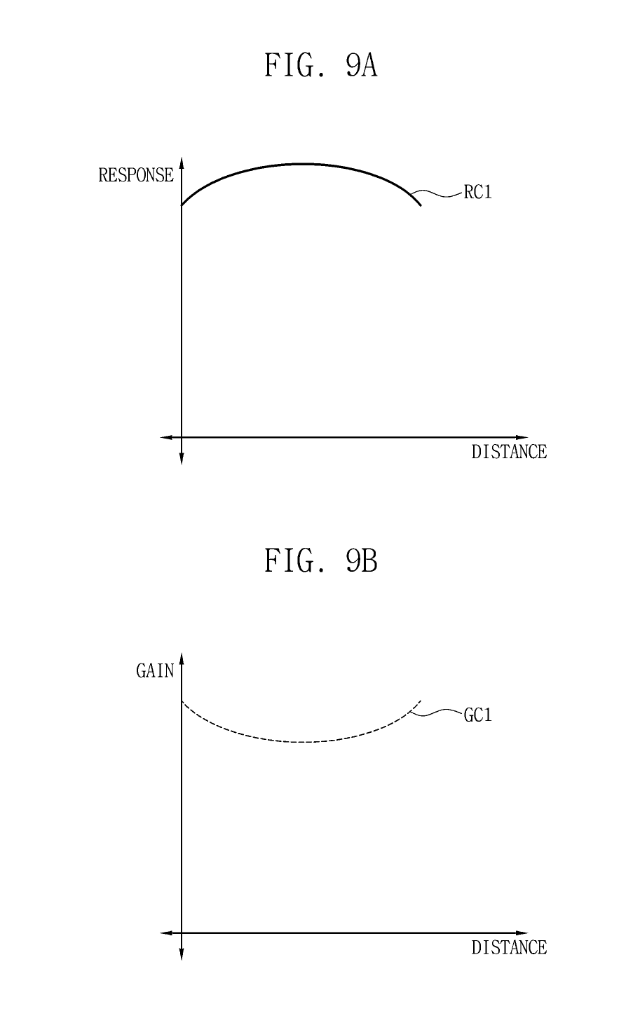

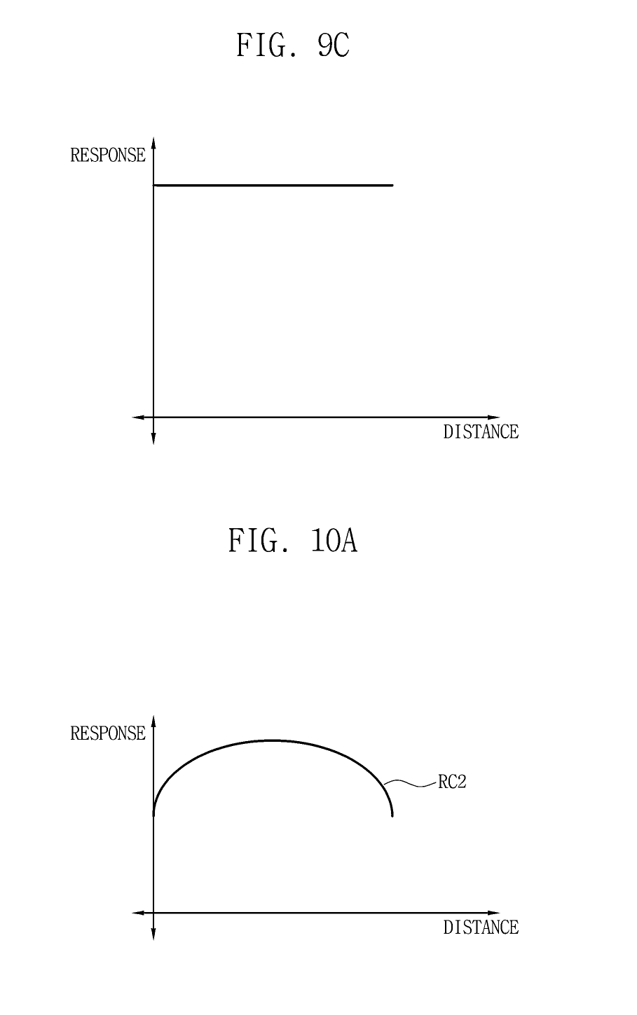

FIG. 9A is a graph illustrating a response curve according to 1 integration time.

Referring to FIG. 9A, X axis represents a distance on an image, and Y axis represents a response according to the distance. For example, the response may have a digital data value of a pixel.

A first response curve RC1 may relate to 1 integration time. The first response curve RC1 may have a maximum value in the center of the image, and have a minimum value in a boundary of the image. That is, the first response curve RC1 may be used as a profile for removing the vignetting effect.

FIG. 9B is a graph illustrating a gain curve according to 1 integration time.

Referring to FIG. 9B, X axis represents a distance on an image, and Y axis represents a gain according to the distance.

A first gain curve GC1 may relate to 1 integration time. The first gain curve GC1 and the first response curve RC1 may be symmetric with respect to the X axis. The first gain curve GC1 may be calculated using this characteristic. The first gain curve GC1 may have a minimum value in the center of the image, and have a maximum value in a boundary of the image.

FIG. 9C is a graph illustrating a result obtained by multiplying the response curve shown in FIG. 9A and the gain curve shown in FIG. 9B.

Referring to FIG. 9C, X axis represents a distance on an image, and Y axis represents a response according to the distance.

A constant response may be obtained in every distance by multiplying the first response curve RC1 and the first gain curve GC1. Accordingly, the vignetting effect can be removed.

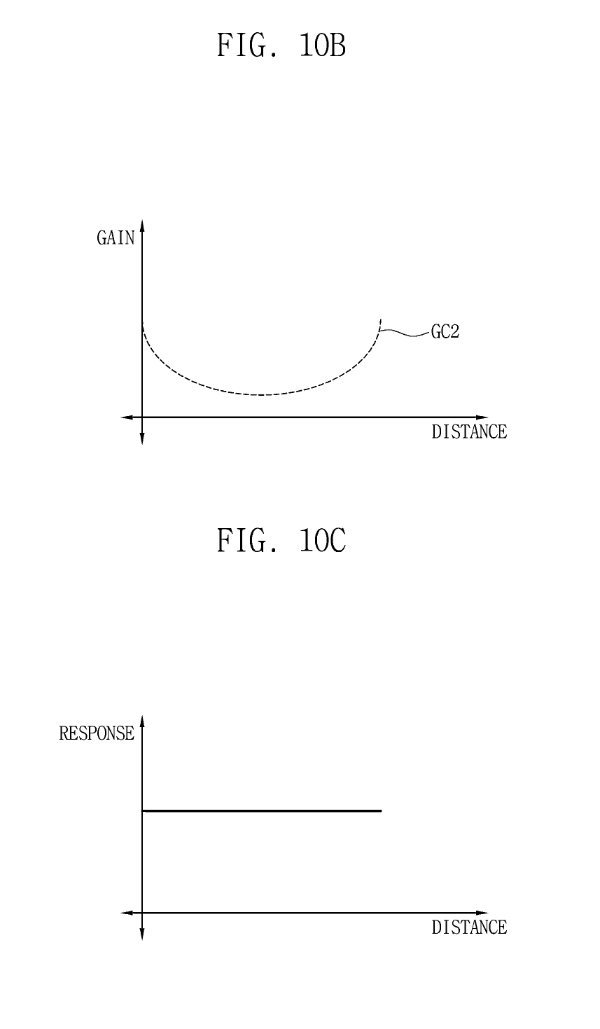

FIG. 10A is a graph illustrating a response curve according to 0.5 integration time.

Referring to FIG. 10A, X axis represents a distance on an image, and Y axis represents a response according to the distance. For example, the response may have a digital data value of a pixel.

A second response curve RC2 may relate to 0.5 integration time. The second response curve RC2 may have a maximum value in the center of an image, and have a minimum value of in a boundary of the image. That is, the second response curve RC2 may be used as a profile for removing the vignetting effect.

FIG. 10B is a graph illustrating a gain curve according to 0.5 integration time.

Referring to FIG. 10B, X axis represents a distance on an image, and Y axis represents a gain according to the distance.

A second gain curve GC2 may relate to 0.5 integration time. The second gain curve GC2 and the second response curve RC2 may by symmetric with respect to the X axis. The second gain curve GC2 may be calculated using this characteristic. The second gain curve GC2 may have a minimum value in the center of the image, and have a maximum value in a boundary of the image.

FIG. 10C is a graph illustrating a result obtained by multiplying the response curve shown in FIG. 10A and the gain curve shown in FIG. 10B.

Referring to FIGS. 10A to 10C, X axis represents a distance on an image, and Y axis represents a response according to the distance.

A constant response may be obtained in every distance by multiplying the second response curve RC2 and the second gain curve GC2. Accordingly, the vignetting effect can be removed.

Next, referring to FIGS. 9A to 10C, the first response curve RC1 of FIG. 9A may be used as a profile with respect to 1 integration time. Further, the second response curve RC2 of FIG. 10A may be used as a profile with respect to 0.5 integration time.

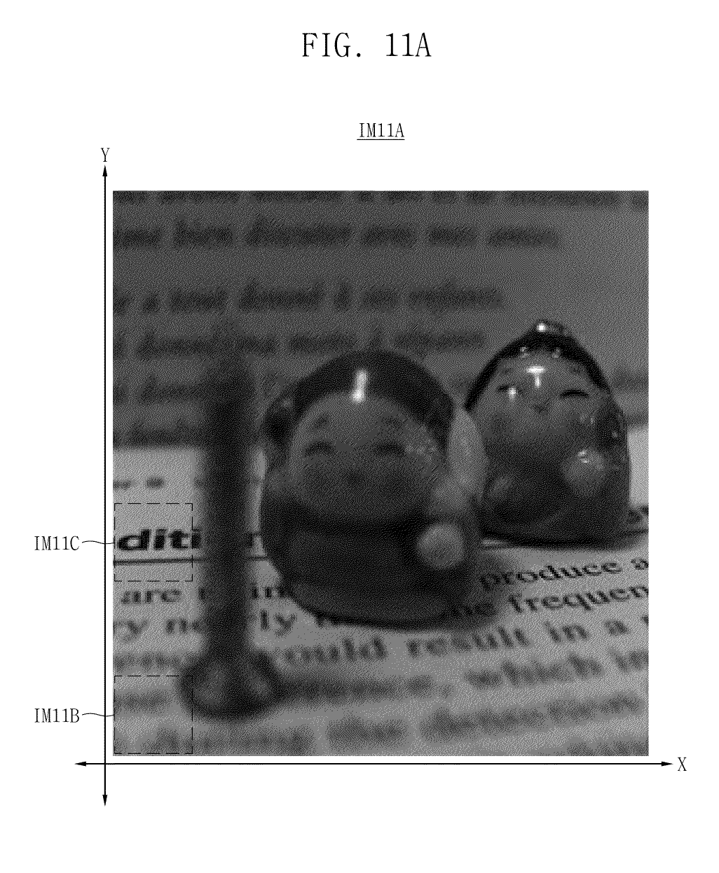

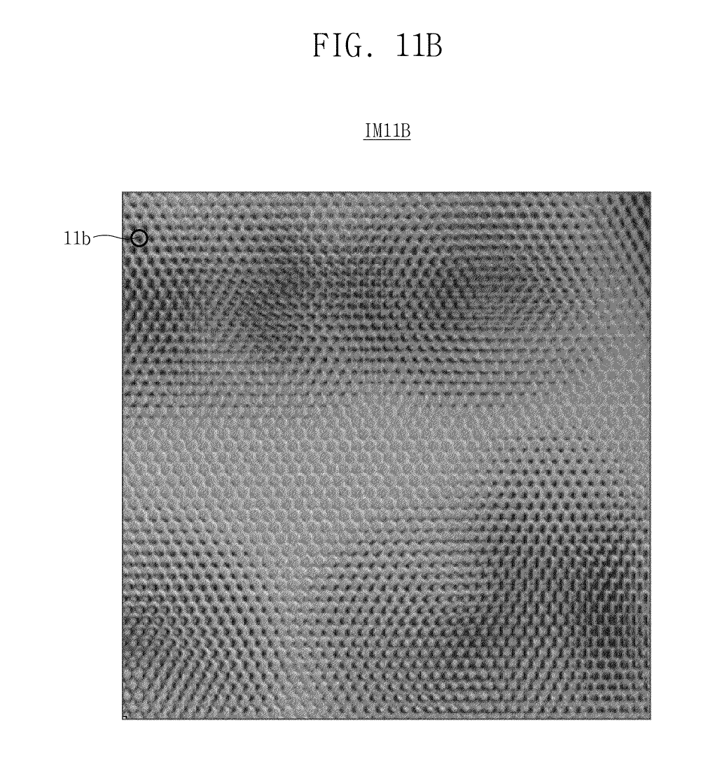

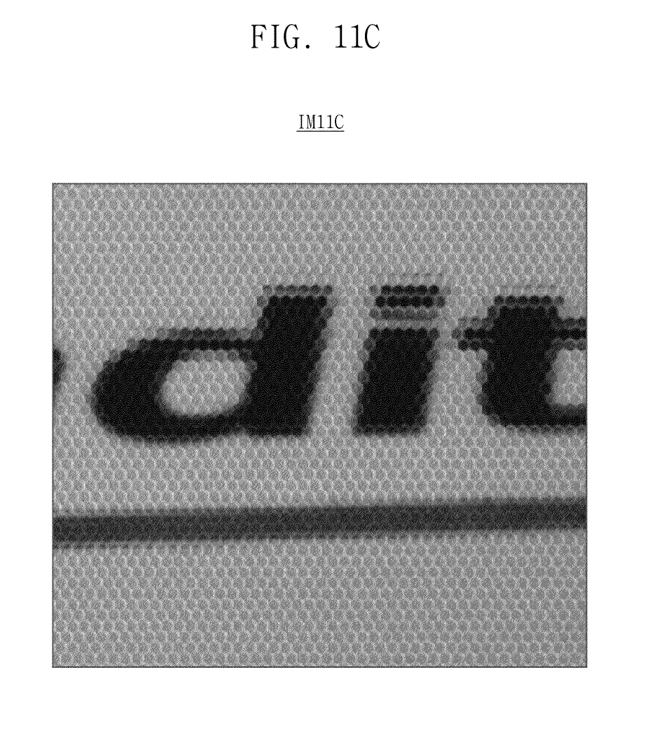

Similarly, the profile may be obtained using the method applied to FIGS. 9A to 10C with respect to a zoom or a focus. FIG. 11A illustrates an image of an object captured by a plenoptic camera device.

Referring to FIGS. 1 and 11A, the plenoptic camera device 10 may capture an image with respect to an object 20 and store the captured image IM11A, like a conventional camera device. Each of a plurality of pixels included in the image IM11A may have x and y axes.

When the plenoptic camera device 10 is focused to the object 20, a clear image is obtained, but when the plenoptic camera device 10 is unfocused to the object 20, a blurred image is obtained. When the plenoptic camera device 10 is unfocused to the object 20, the plenoptic camera device 10 may obtain a more blurred image than the conventional camera device.

After capturing the object 20, when a focus of the plenoptic camera device 10 moves to a blurred portion of the object 20, the plenoptic camera device 10 makes an image of the blurred portion of the object 20 clear.

In the image IM11A, a first portion IM11B is a region which is out of focus, and a second portion IM11C is a region which is in focus.

FIG. 11 B is an enlarged diagram of the first portion 31 of the image shown in FIG. 11A.

Referring to FIGS. 11A and 11B, when enlarging the first portion IM11B, a plurality of lenslets 11b are arranged in a honeycomb shape. In an example embodiment, the mask 12 may include 400×400 lenslets. Since the first portion IM11B is a region which is out of focus, the image IM11A of the first portion 51 is blurred.

FIG. 11C is an enlarged diagram of the second portion 52 of the image shown in FIG. 11A.

Referring to FIGS. 11A and 11C, when enlarging the second portion IM11C, a plurality of lenslets 11b are arranged in a honeycomb shape. Since the second portion 52 is a region which is in focus, the image 50 of the second portion IM11C is clear.

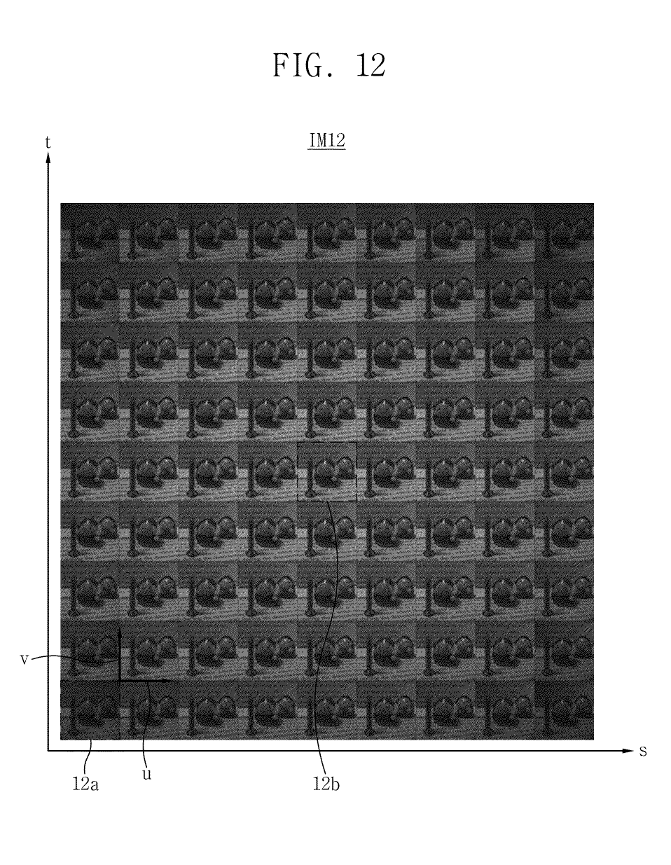

FIG. 12 illustrates an image captured by a plenoptic camera device before applying a shading correction method.

Referring to FIGS. 11A and 12, an image 60 of distributing the image 50 obtained by the plenoptic camera device 10 in units of a lenslet is illustrated.

The image IM12 shown in FIG. 12 is formed by collecting pixels located in the same location of each of the plurality of lenslets in the image IM11A shown in FIG. 11A.

For example, a sub-image 12a may be formed using pixels where a u axis value is 1 and v axis value is 1 among the plurality of sub-images corresponding to the plurality of lenslets in the image IM11A shown in FIG. 11A. Similarly, a sub-image 62 may be formed using pixels where the u axis value is 5 and v axis value is 5 among the plurality of sub-images corresponding to the plurality of lenslets in the image IM11A shown in FIG. 11A.

Due to the vignetting effect, the image IM12 has a difference in brightness between the center and boundary of the image IM12. That is, the sub-image 12a located in the boundary of the image IM12 has the lowest illumination. The sub-image 12b located in the center of the image IM12 has the highest illumination.

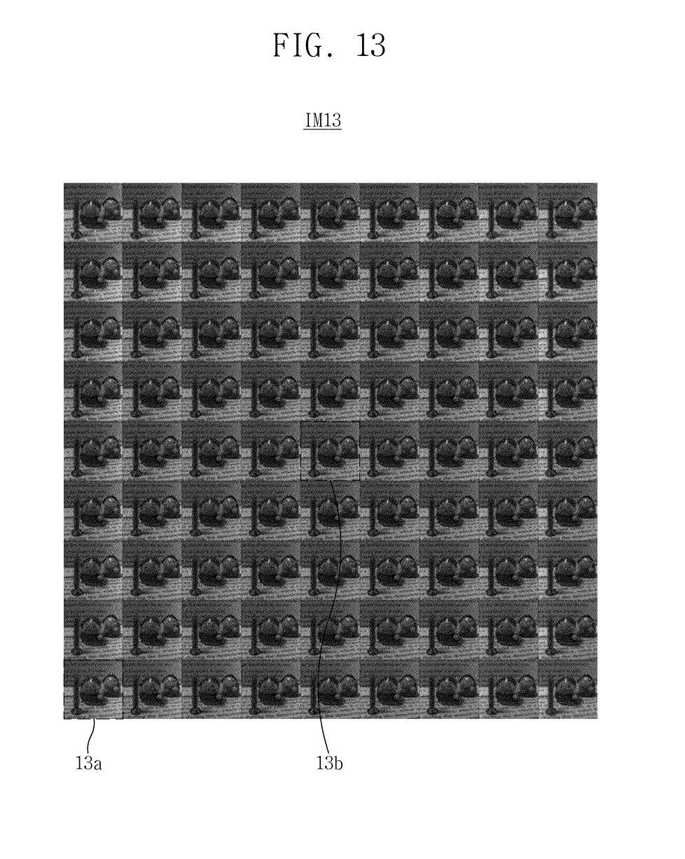

FIG. 13 illustrates an image captured by a plenoptic camera device after applying a shading correction method.

Referring to FIGS. 12 and 13, the plenoptic camera device 10 removes the vignetting effect with respect to the image IM12 shown in FIG. 12.

The image IM13 shown in FIG. 13 is an image that the vignetting effect is removed. Accordingly, there is no difference in brightness between the center and boundary of the image IM13. That is, the sub-image 13a located in the boundary of the image IM13 and the sub-image 13b located in the center of the image IM13 have similar illumination.

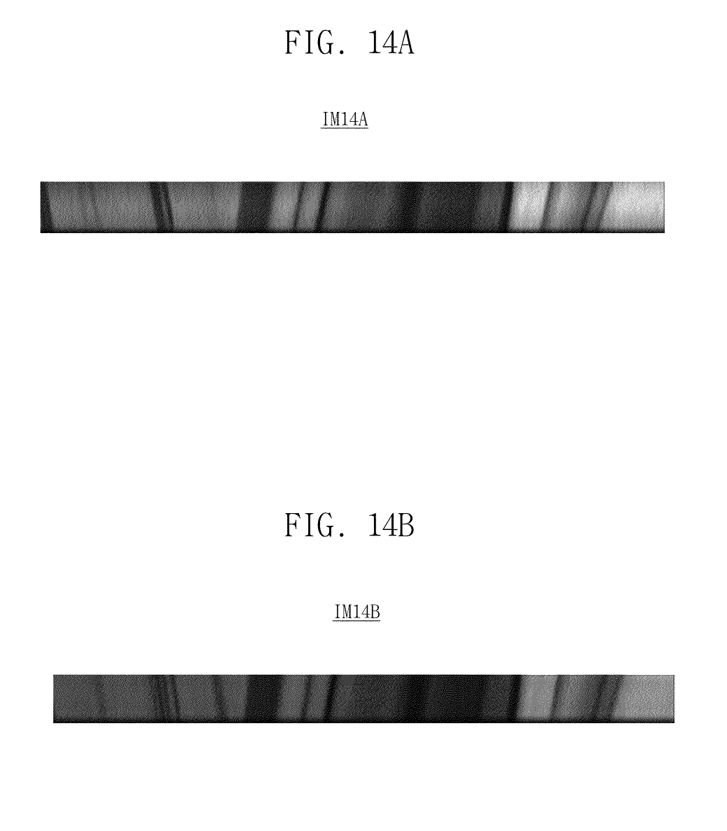

FIG. 14A illustrates an epipolar slice image of the image shown in FIG. 12.

An epipolar slice image IM14A shown in FIG. 14A may be formed by collecting pixels located in horizontal lines in a location (for example, a center location) of the image IM12 shown in FIG. 12. For example, the epipolar slice image is generated by holding the s and u coordinates constant.

Due to the vignetting effect, since the boundary of the image IM12 shown in FIG. 12 is dark and the center of the image IM12 is bright, pixels located in the center line of the epipolar slice image 81 shown in FIG. 14A are bright and pixels located in top and bottom lines of the epipolar slice image IM14A are dark.

Since a straight line inclined to the left is closer than an object which is in focus, the vignetting effect may be generated. Similarly, since a straight line inclined to the right is farther than the object which is in focus, the vignetting effect may not be generated.

When the straight line inclined to the left is changed to a vertical line, since the blurred object is closer than an original focus, the plenoptic camera device 10 makes the blurred object clear. Further, when the straight line inclined to the right is changed to a vertical line, since the blurred object is farther than the original focus, the plenoptic camera device 10 makes the blurred object clear.

Further, a distance to the object which is in focus may be calculated by a declining degree (that is, a gradient) of the straight line inclined to the left or right.

FIG. 14B illustrates an epipolar slice image of the image shown in FIG. 13.

An epipolar slice image IM14B shown in FIG. 14B may be formed by collecting pixels located in horizontal lines of a location of the image IM13 shown in FIG. 13. Since the vignetting effect is removed, pixels located in top, bottom, and center lines of the epipolar slice image IM14B shown in FIG. 14B have uniform brightness.

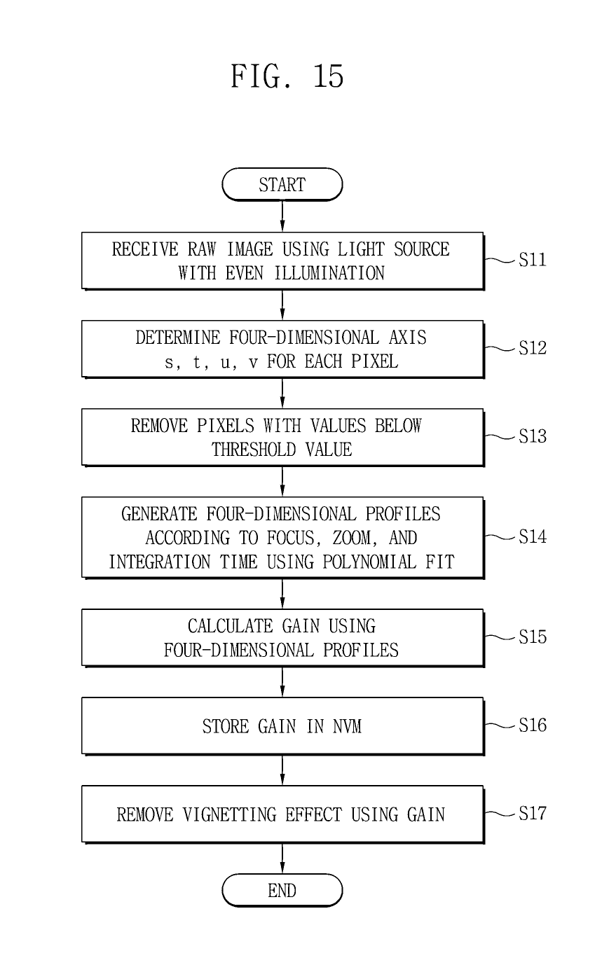

FIG. 15 is a flowchart for explaining a shading correction method of a plenoptic camera device according to an example embodiment of inventive concepts.

Referring to FIGS. 1 and 15, a shading correction method of the plenoptic camera device 10 according to an example embodiment of inventive concepts can obtain a gain for removing the vignetting effect.

Specifically, in step S11, the plenoptic camera device 10 may receive a raw image using a light source with even illumination. That is, the plenoptic camera device 10 determines x, y axes with respect to each of pixels included in the raw image.

In step S12, the plenoptic camera device 10 determines a four-dimensional axis (s, t, u, v) using x and y axes with respect to each of pixels included in the received image. The s and t axes are axes for selecting a sub-image corresponding to each of a plurality of lenslets, and the u and v axes are axes for selecting a pixel in a selected sub-image.

In step S13, the plenoptic camera device 10 may remove pixels with values which are smaller than a threshold value. For example, pixels corresponding to the boundary of the lenslets may have values which are smaller than the threshold value.

In step S14, the plenoptic camera device 10 may generate four-dimensional profiles according to focus, zoom, and integration time by applying a polynomial fit with respect to the pixels with the four-dimensional axis.

In step S15, the plenoptic camera device 10 may calculate a gain for removing the vignetting effect using the four-dimensional profiles.

In step S16, the plenoptic camera device 10 stores the calculated gain in a non-volatile memory device.

In step S17, the plenoptic camera device 10 may remove the vignetting effect using the gain.

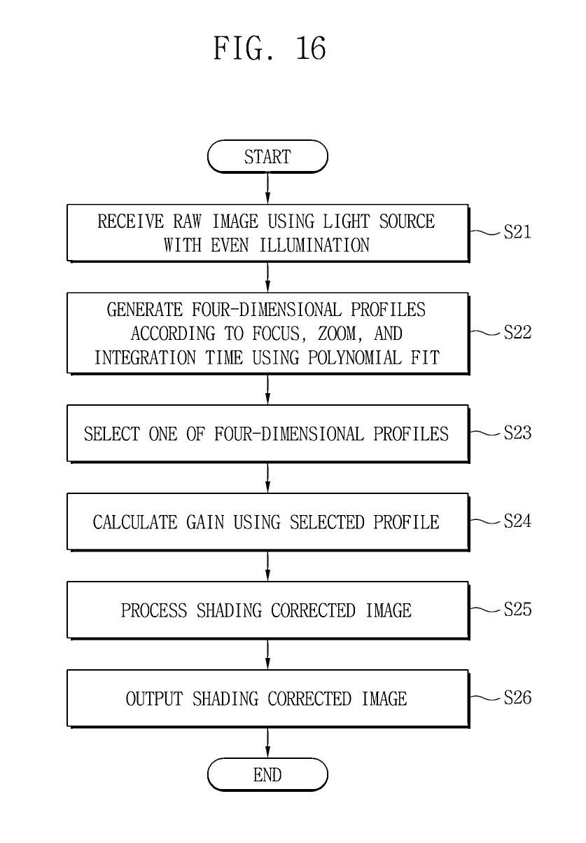

FIG. 16 is a flowchart for explaining a shading correction method of a plenoptic camera device according to another example embodiment of inventive concepts.

Referring to FIGS. 1 and 16, the plenoptic camera device 10 according to another example embodiment of the inventive concept may select a four-dimensional profile according to focus, zoom, and integration time for shading correction.

In step S21, the plenoptic camera device 10 may receive a raw image using a light source with even illumination.

In step S22, the plenoptic camera device 10 may obtain s, t, u, v axes with respect to each of pixels included in the received image. The plenoptic camera device 10 may obtain four-dimensional profiles according to the focus, zoom, and integration time by applying a polynomial fit with respect to pixels with the s, t, u, v axes.

In step S23, the plenoptic camera device 10 may select a profile which has the most similar condition with a predetermined and/or selected condition (a condition designated by a user) among the four-dimensional profiles according to the focus, zoom, and integration time.

For example, the plenoptic camera device 10 may store profiles with respect to a focus distance 40 mm and a focus distance 60 mm. When removing the vignetting effect from the raw image in a focus distance 45 mm, the plenoptic camera device 10 may use a gain obtained by using the profile according to the focus distance 40 mm, or a gain obtained by generating a profile with respect to the focus distance 45 mm by a weight average with respect to the profiles according to the focus distance 40 mm and the focus distance 60 mm, in order to remove the vignetting effect.

In step S24, the plenoptic camera device 10 may calculate a gain using the selected four-dimensional profile. The plenoptic camera device 10 may remove the vignetting effect using the gain.

In step S25, the plenoptic camera device 10 performs image processing on the shading corrected image.

In step S26, the plenoptic camera device 10 outputs the shading corrected image.

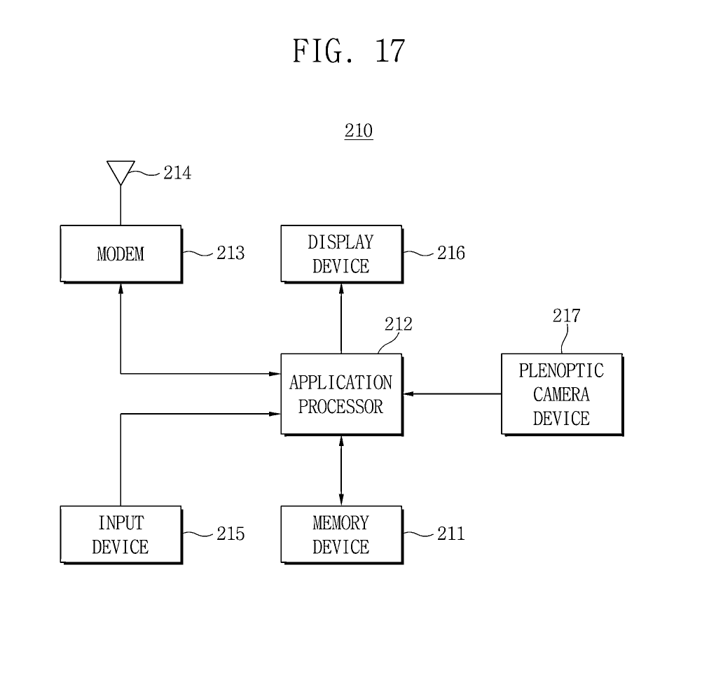

FIG. 17 is a computer system according to an example embodiment of inventive concepts.

Referring to FIG. 17, a computer system 210 may be a personal computer (PC), a network server, a tablet PC, a netbook, an e-reader, a smart phone, a personal digital assistant (PDA), a portable multimedia player (PMP), an MP3 player, or an MP4 player.

The computer system 210 includes a memory device 211, an application processor 212 including a memory controller for controlling the memory device 211, a modem 213, an antenna 214, an input device 215, a display device 216, and a plenoptic camera device 217.

The modem 213 may receive and transmit a radio signal through the antenna 214. For example, the modem 213 may convert the radio signal through the antenna 214 into a signal which can be processed in the application processor 212. In an example embodiment, the modem 213 may be a long term evolution (LTE) transceiver, a high speed downlink packet access/wideband code division multiple access (HSDPA/WCDMA) transceiver, or a global system for mobile communications (GSM) transceiver.

Accordingly, the application processor 212 may process a signal output from the modem 213, and transmit the processed signal to the display device 216. Further, the modem 213 may convert a signal transmitted from the application processor 212 into the radio signal, and output the converted radio signal to an external device through the antenna 214.

The input device 215 is a device which can input a control signal for controlling an operation of the application processor 212, or data being processed by the application processor 212, and may be implemented as a pointing device such as a touch pad or a computer mouse, a keypad, or a keyboard.

The plenoptic camera device 217 may capture an object, and adjust a focus. In an embodiment, the plenoptic camera device 217 may be the plenoptic camera device 10 shown in FIG. 1.

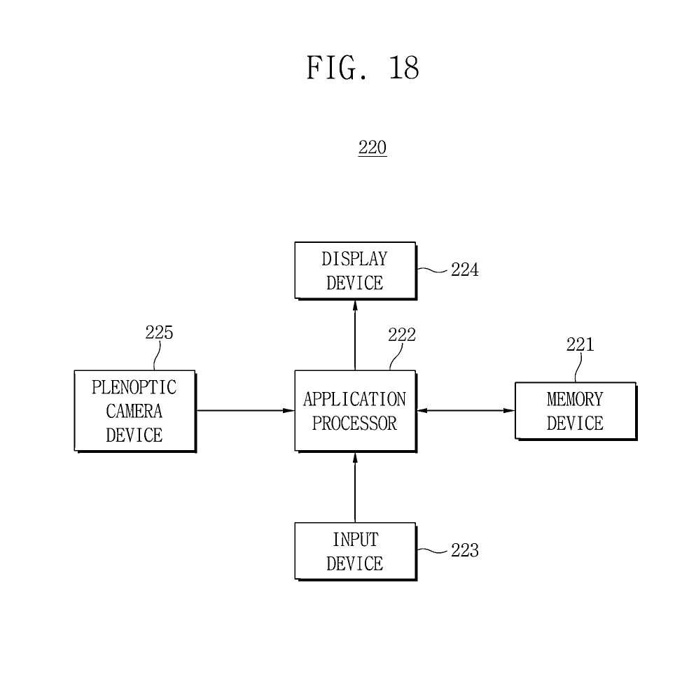

FIG. 18 is a computer system according to another example embodiment of inventive concepts.

Referring to FIG. 18, a computer system 220 may be implemented as an image processing device, for example, a digital camera, or a mobile phone, a smart phone or a tablet PC on which the digital camera is installed.

The computer system 220 including a camera function may operate based on an Android platform.

The computer system 220 further includes a memory device 221, an application processor 222 including a memory controller for controlling a data processing operation, for example, a write operation or a read operation, of the memory device 221, an input device 223, a display device 224, and a plenoptic camera device 225.

The input device 223 is a device for inputting a control signal for controlling an operation of the application processor 222 or data being processed by the application processor 222, and may be implemented as a pointing device such as a touch pad and a computer mouse, a keypad, or a keyboard.

The display device 224 may display data stored in the memory device 221 in response to control of the application processor 222.

The plenoptic camera device 225 may capture an object, and may adjust a focus. In an embodiment, the plenoptic camera device 225 may be the plenoptic camera device 10 shown in FIG. 1.

The plenoptic camera device according to example embodiments of inventive concepts can remove the vignetting effect by applying the shading correction method.

The foregoing is illustrative of example embodiments and is not to be construed as limiting thereof. Although a few example embodiments have been described, those skilled in the art will readily appreciate that many modifications are possible without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures.

What is claimed is:

1. A method, comprising:
receiving a raw image;
determining a four-dimensional axis with respect to the raw image;
generating a four-dimensional profile by applying a polynomial fit with respect to a plurality of pixels in the raw image based on the four-dimensional axis; and
calculating a gain using the four-dimensional profile.

2. The method according to claim 2, further comprising:
removing pixels with values that are equal to or smaller than a threshold value among the plurality of pixels.

3. The method according to claim 2, wherein the determining of the four-dimensional axis, comprises:
determining a two-dimensional axis for selecting one of a plurality of sub-images corresponding to a plurality of lenslets; and
determining a two-dimensional axis for selecting a pixel in the selected sub-image.

4. The method according to claim 3, wherein the two-dimensional axis for selecting one of the plurality of the sub-images includes a first horizontal axis and a first vertical axis for selecting the sub-image, and the two-dimensional axis for selecting the pixel in the selected sub-image one among the pixels includes a second horizontal axis and a second vertical axis.

5. The method according to claim 1, wherein the generating the four-dimensional profile comprises:
generating the four-dimensional profile according to a focus, a zoom, and an integration time of the plenoptic camera device.

6. The method according to claim 1, further comprising:
removing a vignetting effect using the gain.

7. A method of correcting shading in an image, the method comprising:
obtaining data values from an image sensor array having a plurality of pixels, the image sensor array being modeled as a four dimensional surface, the data values being in accordance with a response curve; and
applying gain values to the data values, respectively, in accordance with a gain curve, the gain curve being symmetric to the response curve with respect to an axis.

8. The method of claim 7, wherein the axis represents a distance from a location in the image sensor array.

9. The method of claim 7, wherein the response curve has a minimum value corresponding to a boundary of the image sensor array and a maximum value corresponding to a center of the image sensor array.

10. The method of claim 7, wherein the gain curve has a minimum value corresponding to a center of the image sensor array and a maximum value corresponding to a boundary of the image sensor array.
